(19) United States
(12) Patent Application Publication
(10) Pub. No.: US 2025/0030188 A1
(43) Pub. Date: Jan. 23, 2025

(54) TERMINAL UNIT, FEMALE TERMINAL, AND MALE TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Yuya TSUKAMOTO, Mie (JP)

(21) Appl. No.: 18/713,899

(22) PCT Filed: Nov. 29, 2022
(86) PCT No.: PCT/JP2022/043902

§ 371 Date: May 28, 2024

(30) Foreign Application Priority Data
Dec. 10, 2021 (JP) 2021-201087

(51) Int. Cl. H01R 13/18; H01R 13/04

(52) U.S. Cl. CPC H01R 13/18; H01R 13/04

(57) ABSTRACT

A terminal unit includes a male terminal and a female terminal. The female terminal includes a first contact portion, a second contact portion and spring members. The male terminal includes a pair of inclined portions. The first contact portion includes a pair of first inclined side edge parts along the inclined portions. Each first inclined side edge part is provided with a first contact point portion. The second contact portion includes a pair of second inclined side edge parts along the inclined portions. Each second inclined side edge part is provided with a second contact point portion. The spring members include a first spring member and a second spring member for biasing the first and second inclined side edge parts in directions toward each other. The first and second spring members press the first and second contact point portions against the inclined portions press-fit between those contact point portions.

### TECHNICAL FIELD

The present disclosure relates to a terminal unit and a female terminal, and a male terminal used in the terminal unit.

### BACKGROUND

Patent Document 1 discloses a terminal unit composed of a male terminal having a plate shape expressed as a tab shape or the like and a female terminal to be connected to the male terminal. The female terminal includes a pair of wall portions arranged to face each other across a male terminal insertion gap, one wall portion is provided with a resilient contact piece for pressing the male terminal against the other wall portion, and a plurality of contact points project on the other wall portion.

### PRIOR ART DOCUMENT

### Patent Document

Patent Document 1: JP 2017-204396 A

### SUMMARY OF THE INVENTION

### Problems to be Solved

Since the terminal unit of Patent Document 1 is structured such that the plate-like male terminal is sandwiched between the pair of wall portions of the female terminal, a gripping force for the male terminal against an external force in a plate width direction is small. Thus, a contact resistance value possibly increases due to slight sliding friction between the male and female terminals caused by vibration or the like. Therefore, a further improvement of the terminal unit has been required.

Accordingly, a terminal unit and a female terminal and a male terminal used in the terminal unit are disclosed which can suppress an increase of a contact resistance value due to slight sliding friction between the male and female terminals by suppressing a displacement of the male terminal in a plate width direction with respect to the female terminal.

### Means to Solve the Problem

A terminal unit of the present disclosure is provided with a plate-like male terminal and a female terminal to be connected to the male terminal, the female terminal including a first contact portion and a second contact portion arranged to face each other across a male terminal press-fit gap, the male terminal being press-fit into and arranged in the male terminal press-fit gap, and spring members for biasing the first and second contact portions in directions toward each other, the male terminal including a pair of inclined portions inclined toward one side in a plate thickness direction of the male terminal on both sides in a plate width direction intersecting a press-fitting direction into the male terminal press-fit gap, the first contact portion of the female terminal including a pair of first inclined side edge parts facing a surface on the one side in the plate thickness direction of the male terminal, the first inclined side edge parts being inclined along the pair of inclined portions of the male terminal, a first contact point portion projecting toward the male terminal press-fit gap being provided on each first inclined side edge part, the second contact portion of the female terminal including a pair of second inclined side edge parts facing a surface on the other side in the plate thickness direction of the male terminal, the second inclined side edge parts being inclined along the pair of inclined portions of the male terminal, a second contact point portion projecting toward the male terminal press-fit gap being provided on each second inclined side edge part, the spring members including a first spring member for biasing the first and second inclined side edge parts arranged and located on one side in the plate width direction in directions toward each other and a second spring member for biasing the first and second inclined side edge parts arranged and located on the other side in the plate width direction in directions toward each other, the first spring member pressing the first contact point portion of the first inclined side edge part and the second contact point portion of the second inclined side edge part located on the one side in the plate width direction against the inclined portion of the male terminal press-fit between the first and second contact point portions, and the second spring member pressing the first contact point portion of the first inclined side edge part and the second contact point portion of the second inclined side edge part located on the other side in the plate width direction against the inclined portion of the male terminal press-fit between the first and second contact point portions.

A female terminal of the present disclosure is a female terminal used in the terminal unit of the present disclosure.

A male terminal of the present disclosure is a male terminal used in the terminal unit of the present disclosure.

### Effect of the Invention

According to the present disclosure, it is possible to provide a terminal unit and a female terminal and a male terminal used in the terminal unit, which are capable of suppressing an increase of a contact resistance value due to slight sliding friction between the male and female terminals by suppressing a displacement of the male terminal in a plate width direction with respect to the female terminal.

### BRIEF DESCRIPTION OF THE DRAWINGS

FIG. 1 is a perspective view of a terminal unit according to a first embodiment in a fitting state of a male terminal and a female terminal.

FIG. 2 is a plan view of the terminal unit shown in FIG. 1.

FIG. 3 is a section along III-III in FIG. 2.

FIG. 4 is a section along IV-IV in FIG. 2.

FIG. 5 is an exploded perspective view showing a state before spring members are assembled in the female terminal constituting the terminal unit shown in FIG. 1.

FIG. 6 is a transverse section, corresponding to FIG. 4, of the female terminal shown in FIG. 5.

FIG. 7 is a perspective view of the female terminal constituting the terminal unit shown in FIG. 1 showing a state where the spring members are assembled in the female terminal shown in FIG. 5.

FIG. 8 is a transverse section, corresponding to FIG. 3, of the female terminal shown in FIG. 7.

FIG. 9 is a perspective view showing a terminal unit according to a second embodiment in a fitting state of a male terminal and a female terminal.

FIG. 10 is an exploded perspective view showing a state before spring members are assembled in the female terminal constituting the terminal unit shown in FIG. 9.

FIG. 11 is a longitudinal section along XI-XI in FIG. 9 of the female terminal constituting the terminal unit shown in FIG. 9.

### DETAILED DESCRIPTION TO EXECUTE THE INVENTION

### Description of Embodiments of Present Disclosure

First, embodiments of the present disclosure are listed and described.

(1) The terminal unit of the present disclosure is provided with a plate-like male terminal and a female terminal to be connected to the male terminal, the female terminal including a first contact portion and a second contact portion arranged to face each other across a male terminal press-fit gap, the male terminal being press-fit into and arranged in the male terminal press-fit gap, and spring members for biasing the first and second contact portions in directions toward each other, the male terminal including a pair of inclined portions inclined toward one side in a plate thickness direction of the male terminal on both sides in a plate width direction intersecting a press-fitting direction into the male terminal press-fit gap, the first contact portion of the female terminal including a pair of first inclined side edge parts facing a surface on the one side in the plate thickness direction of the male terminal, the first inclined side edge parts being inclined along the pair of inclined portions of the male terminal, a first contact point portion projecting toward the male terminal press-fit gap being provided on each first inclined side edge part, the second contact portion of the female terminal including a pair of second inclined side edge parts facing a surface on the other side in the plate thickness direction of the male terminal, the second inclined side edge parts being inclined along the pair of inclined portions of the male terminal, a second contact point portion projecting toward the male terminal press-fit gap being provided on each second inclined side edge part, the spring members including a first spring member for biasing the first and second inclined side edge parts arranged and located on one side in the plate width direction in directions toward each other and a second spring member for biasing the first and second inclined side edge parts arranged and located on the other side in the plate width direction in directions toward each other, the first spring member pressing the first contact point portion of the first inclined side edge part and the second contact point portion of the second inclined side edge part located on the one side in the plate width direction against the inclined portion of the male terminal press-fit between the first and second contact point portions, and the second spring member pressing the first contact point portion of the first inclined side edge part and the second contact point portion of the second inclined side edge part located on the other side in the plate width direction against the inclined portion of the male terminal press-fit between the first and second contact point portions.

According to the terminal unit of the present disclosure, the female terminal includes the first and second contact portions arranged to face each other across the male terminal press-fit gap, and the male terminal press-fit into the male terminal press-fit gap is sandwiched between the first and second contact portions. The male terminal includes the pair of inclined portions inclined toward the one side in the plate thickness direction of the male terminal on the both sides in the plate width direction of the male terminal, which is a direction intersecting the press-fitting direction into the male terminal press-fit gap. Similarly, the first contact portion of the female terminal includes the pair of first inclined side edge parts (first contact point portions) facing the surface on the one side in the plate thickness direction of the male terminal and respectively inclined along the pair of inclined portions of the male terminal, and the second contact portion of the female terminal includes the pair of second inclined side edge parts (second contact point portions) facing the surface on the other side in the plate thickness direction of the male terminal and respectively inclined along the pair of inclined portions of the male terminal. Further, the first contact point portion of the first inclined side edge part and the second contact point portion of the second inclined side edge part of the female terminal located on the one side in the plate width direction of the male terminal are pressed against the inclined portion of the male terminal press-fit between those contact point portions by the first spring member, and the first contact point portion of the first inclined side edge part and the second contact point portion of the second inclined side edge part of the female terminal located on the one side in the plate width direction of the male terminal are pressed against the inclined portion of the male terminal press-fit between those contact point portions by the second spring member. In this way, if an external force is applied to the male terminal in the plate width direction, the inclined portions of the male terminal are pressed by (the first contact point portions of the first inclined side edge parts) and the second contact point portions of the second inclined side edge parts of the female terminal similarly inclined, and force components (reaction forces from the first and second contact point portions) acting inward in the plate width direction are generated. As a result, a force for preventing a displacement of the male terminal in response to an external force acting outward in the plate width direction of the male terminal can be increased as compared to conventional structures, and a displacement of the male terminal in the plate width direction with respect to the female terminal can be suppressed.

Moreover, the inclined portions of the male terminal are sandwiched between the similarly inclined first and second inclined side edge parts of the female terminal on the both sides in the plate width direction of the male terminal, and contact pressures can be applied to the inclined portions of the male terminal from the both sides in the plate thickness direction by the separate spring members (first spring member and second spring member). As a result, a state where the first and second contact point portions of the female terminal are pressed against the respective inclined portions of the male terminal can be maintained with stable contact pressures, displacement suppression performance against an external force in the plate width direction of the male terminal can be further improved and slight sliding friction between the male and female terminals can be more advantageously suppressed. Further, since the first and second inclined side edge parts of the female terminal provided with the first and second contact point portions are inclined along the inclined portions of the male terminal, large contact areas of the first and second contact point portions of the female terminal with the male terminal can be ensure, and continuity resistance between the male and female terminals can also be reduced.

Here, the pair of first inclined side edge parts and the pair of second inclined side edge parts “respectively inclined along the pair of inclined portions of the male terminal” only have to be inclined along the inclined portions of the male terminal and the inclined portions of the male terminal and the first and second inclined side edge parts may not necessarily be parallel. For example, an angle of inclination of the first/second inclined side edge part may be different from that of the inclined portion of the male terminal within a range of about 0 to 10°.

Further, since the contact point portions (first and second contact point portions) of the female terminal with the male terminal are distributed and arranged on the pairs of inclined side edge parts and pressed against the male terminal by the separate spring members, necessary pressing forces can be stably applied to the contact point portions distributed and arranged between the male and female terminals while each spring member is reduced in size. Particularly, since the first and second spring members are not interposed between the male terminal and the first and second contact point portions of the female terminal, contact resistance between the male and female terminals can be more advantageously reduced.

Note that any structure can be adopted for the first and second contact point portions of the female terminal if these contact point portions can allow the male terminal to be press-fit into the male terminal press-fit gap and sandwich the male terminal therebetween. For example, an arbitrary structure can be adopted if at least one of the first and second contact portions is displaceable in a direction opposite to a facing direction across the male terminal press-fit gap and the first and second contact portions are biased in the facing direction across the male terminal press-fit gap by the spring members.

(2) Preferably, the male terminal includes a central flat portion arranged between the pair of inclined portions in the plate width direction, the first contact portion of the female terminal includes a first flat portion arranged between the pair of first inclined side edge parts in the plate width direction and facing and extending along the central flat portion of the male terminal, and the second contact portion of the female terminal includes a second flat portion arranged between the pair of second inclined side edge parts in the plate width direction and facing and extending along the central flat portion of the male terminal.

The male terminal includes the central flat portion and the pair of inclined portions inclined toward the same side in the plate thickness direction on both sides of the central flat portion, and the first and second contact portions of the female terminal are arranged on both sides in the plate thickness direction of the male terminal and have a shape similar to the male terminal. That is, the first contact portion includes the first flat portion extending along the central flat portion of the male terminal and the first inclined side edge parts arranged on both sides of the first flat portion and inclined along the pair of inclined portions of the male terminal, and the second contact portion includes the second flat portion extending along the central flat portion of the male terminal and the second inclined side edge parts arranged on both sides of the second flat portion and inclined along the pair of inclined portions of the male terminal. Since the male terminal and the first and second contact portions of the female terminal are arranged to face each other while having similar shapes, unnecessary gaps are not formed in the terminal unit itself and the terminal unit can be reduced in size.

(3) Preferably, the first contact portion of the female terminal includes an abutting portion, the second contact portion of the female terminal includes an abutted portion for coming into contact with the abutting portion, and displacements of the first and second contact portions in the directions toward each other are prevented by the contact of the abutting portion and the abutted portion. Excessive displacements of the first and second contact portions in the approaching directions by the spring members are prevented by the mutual contact of the abutting portion and the abutted portion respectively provided on the first and second contact portions of the female terminal. As a result, the male terminal press-fit gap provided between the facing surfaces of the first and second contact portions can be reliably ensured and insertion resistance at the time of inserting the male terminal into the male terminal press-fit gap can be reduced.

(4) Preferably, the first contact portion includes a pair of the abutting portions respectively provided on the pair of first inclined side edge parts, the second contact portion includes a pair of the abutted portions respectively provided on the pair of second inclined side edge parts, and displacements of the respective first inclined side edge parts and the respective second inclined side edge parts in the directions toward each other are prevented by the contact of the respective abutting portions and the respective abutted portions. Displacements of the first and second side edge parts in the mutually approaching directions by the first and second spring members can be prevented by the direct contact of the abutting portions provided on the respective first inclined side edge parts and the abutted portions provided on the respective second inclined side edge parts. Thus, the male terminal press-fit gap between the first and second inclined side edge parts including the first and second contact point portions where insertion resistance of the male terminal is highest is reliably ensured, and an insertion force for the male terminal can be advantageously reduced.

(5) Preferably, each of the first and second spring members is constituted by a leaf spring clip including a first plate portion to be overlapped on an outer surface of the first inclined side edge part, a second plate portion to be overlapped on an outer surface of the second inclined side edge part and a coupling plate portion coupling the first and second plate portions. By constituting the first and second spring members by the leaf spring clips, the structure of the terminal unit itself can be simplified. Moreover, the respective plate portions of the leaf spring clips can be overlapped and arranged on the outer surfaces of the respective inclined side edge parts of the female terminal, and the miniaturization of the terminal unit can be advantageously achieved.

(6) Preferably, each of the first and second contact portions of the female terminal has a rectangular plate shape, has one end side in a longitudinal direction coupled to a base end part of the female terminal and is cantilevered from the base end part, the first inclined side edge part and the second inclined side edge part located on the one side in the plate width direction of the male terminal are provided on one side in the plate width direction of each of the first and second contact portions, the first inclined side edge part and the second inclined side edge part located on the other side in the plate width direction of the male terminal are provided on the other side in the plate width direction of each of the first and second contact portions, and the male terminal press-fit gap provided between facing surfaces of the first and second contact portions is open toward projecting end sides of the first and second contact portions. This is because the female terminal including the male terminal press-fit gap open forward can be efficiently manufactured only by providing the first and second inclined side edge parts respectively on the one side and the other side in the plate width direction of the first and second contact portions having a rectangular plate shape and arranging the first and second inclined side edge parts to face each other.

(7) Preferably, a locking claw projecting toward the male terminal press-fit gap is provided on a tip part of at least one of the first and second plate portions of each of the first and second spring members, and engaged portions are respectively provided on the one side and the other side in the plate width direction of the first and second contact portions at least in one of the first and second contact portions, and the respective locking claws of the first and second spring members are engaged with the engaged portions. This is because the first and second spring members can be assembled with the first and second contact portions inseparably in the plate width direction of the male terminal while the insertion of the male terminal into the male terminal press-fit gap open forward of the first and second contact portions is allowed. In this way, the terminal unit in which the male terminal can be connected to the female terminal from front and a stable contact pressure can be ensured even if the male terminal is repeatedly inserted into and withdrawn from the female terminal can be stably realized without causing enlargement.

(8) Preferably, a through hole penetrating in a plate thickness direction is provided in the coupling plate portion of each of the first and second spring members, the abutting portion and the abutted portion are provided to project outward in the plate width direction of the first and second contact portions and arranged by being inserted into the through hole of the first spring member on the one side in the plate width direction of the first and second contact portions, and the abutting portion and the abutted portion are provided to project outward in the plate width direction of the first and second contact portions and arranged by being inserted into the through hole of the second spring member on the other side in the plate width direction of the first and second contact portions. Since the abutting portions and the abutted portions provided to project outward on the one side and the other side in the plate width direction of the first and second contact portions are inserted into and arranged in the through holes provided in the coupling plates of the respective first and second spring members, the first and second spring members are prevented from being displaced or detached from the first and second contact portions toward both sides in the longitudinal direction by the contact of the abutting portions and the abutted portions with the through holes. In this way, the terminal unit in which the male terminal can be connected to the female terminal from front and a stable contact pressure can be ensured even if the male terminal is repeatedly inserted into and withdrawn from the female terminal can be stably realized without causing enlargement.

(9) Preferably, each of the first and second contact portions of the female terminal has a rectangular plate shape, has one end side in a longitudinal direction coupled to a base end part of the female terminal and is cantilevered from the base end part, the first inclined side edge part and the second inclined side edge part located on the one side in the plate width direction are provided on projecting end parts of the first and second contact portions, the first inclined side edge part and the second inclined side edge part located on the other side in the plate width direction are provided on sides of the first and second contact portions closer to the base end part than the projecting end parts, and the male terminal press-fit gap provided between facing surfaces of the first and second contact portions is open at one side surface in the plate width direction of each of the first and second contact portions. This is because the female terminal including the male terminal press-fit gap open laterally can be efficiently manufactured only by providing the first and second inclined side edge parts respectively on the projecting end parts of the first and second contact portions having the rectangular plate shape and on the side closer to the base end than the projecting end parts and arranging the first and second inclined side edge parts to face each other.

(10) Preferably, a locking claw projecting toward the male terminal press-fit gap is provided on a tip part of at least one of the first and second plate portions of each of the first and second spring members, and the locking claws are engaged with the one side surface of the first or second contact portions. This is because the first and second spring members can be assembled with the first and second contact portions inseparably in the plate width direction while the insertion of the male terminal into the male terminal press-fit gap open at the one side surface of each of the first and second contact portions is allowed. In this way, the terminal unit in which the male terminal can be connected to the female terminal from a lateral side and a stable contact pressure can be ensured even if the male terminal is repeatedly inserted into and withdrawn from the female terminal can be stably realized without causing enlargement.

(11) Preferably, stopper protrusions are provided to project outward on both sides of an engaged part to be engaged with the locking claw in the longitudinal direction on the one side surface in the plate width direction of at least one of the first and second contact portions. This is because the stopper protrusions are provided to project outward on the both sides in the longitudinal direction across the first and/or second locking claws in at least one of the first and second contact portions, and the first and second spring members are prevented from being displaced or detached toward both sides in the longitudinal direction by the contact of the locking claw with the stopper protrusions. In this way, the terminal unit in which the male terminal can be connected to the female terminal from a lateral side and a stable contact pressure can be ensured even if the male terminal is repeatedly inserted into and withdrawn from the female terminal can be stably realized without causing enlargement.

(12) Preferably, the first contact point portions on the first inclined side edge part are provided at a plurality of positions separated from each other in an insertion direction of the male terminal, and the second contact point portions on the second inclined side edge part are provided at a plurality of positions separated from each other in the insertion direction of the male terminal. The first and second contact point portions to be pressed into contact with the male terminal while sandwiching the inclined portions of the male terminal are distributed and provided at the plurality of positions separated from each other in the insertion direction of the male terminal. In this way, the inclined portions of the male terminal can be held at widely distributed pressing points and can be stably sandwiched between the first and second inclined side edge parts, and a rotational displacement of the male terminal can be advantageously suppressed or prevented.

(13) Preferably, the first and second spring members include first protrusions for applying biasing forces to the first inclined side edge parts in a concentrated manner and second protrusions for applying biasing forces to the second inclined side edge parts in a concentrated manner, and the second protrusion continuously extends in an insertion direction of the male terminal while having an arcuate cross-sectional shape and the first protrusion has a hemispherical shape projecting toward an intermediate part in an extending direction of the second protrusion. Biasing forces of the respective spring members are applied in a concentrated manner by the first protrusions from the side of the first inclined side edge parts, and constant biasing forces are applied over a wide range of an insertion region in the insertion direction of the male terminal by the second protrusions from the side of the second inclined side edge parts. In this way, a displacement of the male terminal in the plate width direction can be more advantageously suppressed or prevented by efficiently and stably applying the biasing forces of the respective spring members between the first and second inclined side edge parts and more stably sandwiching the inclined portions of the male terminal. Further, by forming the first protrusions, out of the first and second protrusions, into a hemispherical shape, the male terminal can be stably biased even if the male terminal is press-fit into the male terminal press-fit gap and the first and second contact portions are inclined about the base end part.

(14) The female terminal of the present disclosure is used in the terminal unit according to any one of (1) to (13) described above.

(15) The male terminal of the present disclosure is used in the terminal unit according to any one of (1) to (13) described above.

### Details of Embodiments of Present Disclosure

Specific examples of a terminal unit of the present disclosure and a female terminal and a male terminal used in the terminal unit are described below with reference to the drawings. Note that the present disclosure is not limited to these illustrations, but is represented by claims and intended to include all changes in the scope of claims and in the meaning and scope of equivalents.

### First Embodiment

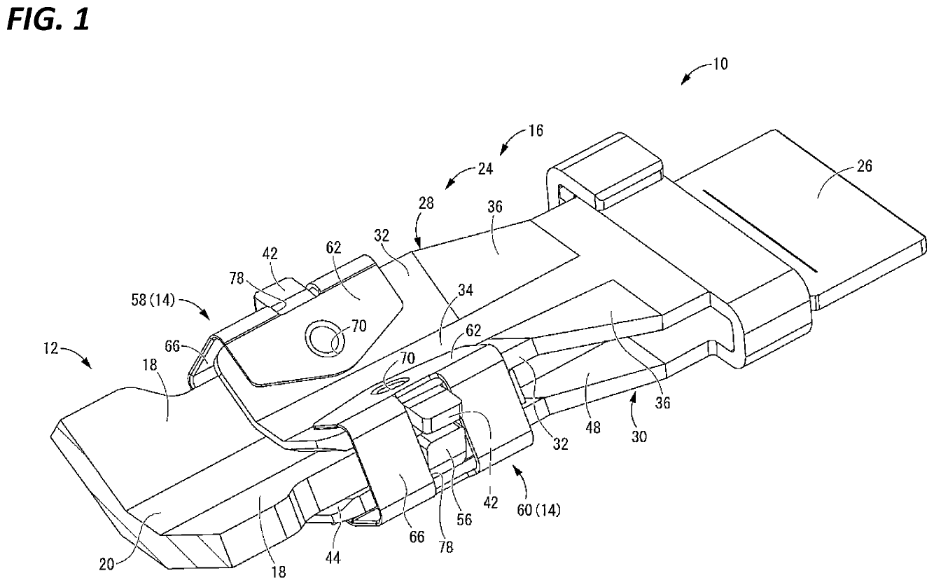

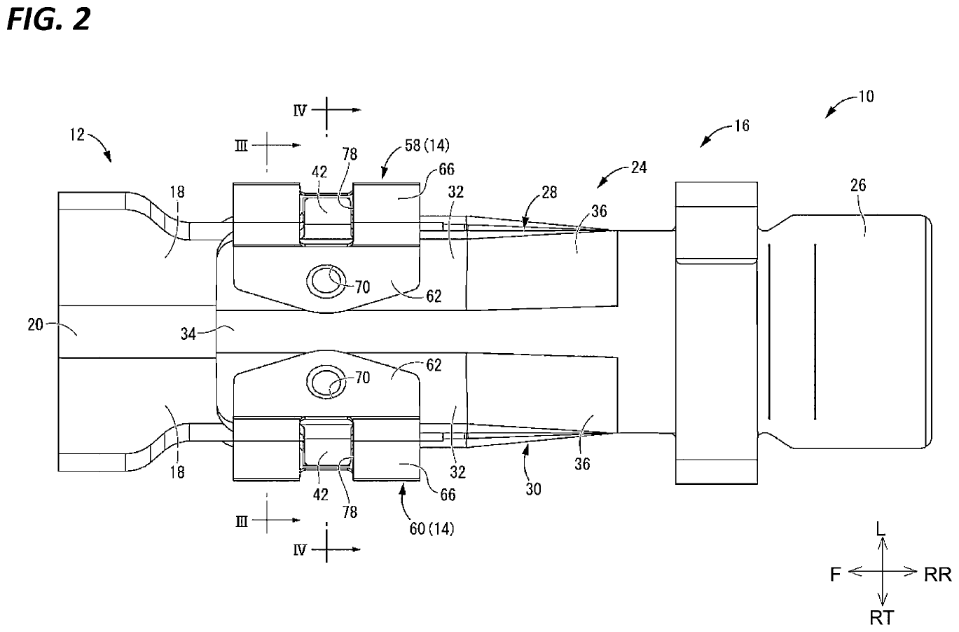

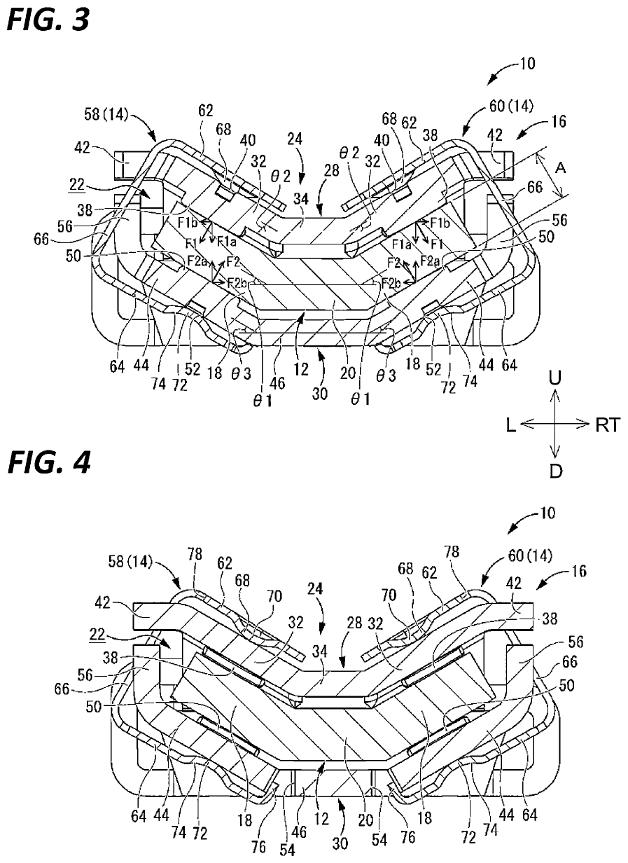

Hereinafter, a terminal unit 10 of a first embodiment of the present disclosure is described using FIGS. 1 to 8. The terminal unit 10 is provided with a plate-like male terminal 12 and a female terminal 16 to be connected to the male terminal 12. The female terminal 16 includes spring members 14 (first spring member 58 and second spring member 60 to be described later) for biasing a first contact portion 28 and a second contact portion 30 forming a male terminal press-fit gap 22 to be described later in directions toward each other. The male terminal 12 and the female terminal 16 are electrically connected by the male terminal 12 being press-fit and inserted into the female terminal 16 and contacting the female terminal 16. Note that the terminal unit 10 can be arranged in an arbitrary orientation, but upper and lower sides are upper and lower side in FIG. 3, left and right sides are upper and lower sides in FIG. 2 and front and rear sides are left and right sides in FIG. 2 in the following description. Further, for a plurality of identical members, only some members may be denoted by a reference sign and the others may not be denoted by the reference sign.

### (Male Terminal 12)

The male terminal 12 is plate-like as a whole and constituted using an unillustrated flat metal fitting. The flat metal fitting has a substantially rectangular shape as a whole, has predetermined plate width and plate thickness and extends straight. Note that, in the male terminal 12, an end part on a tip side (rear side in FIG. 1) in an insertion direction, in which the male terminal 12 is press-fit and inserted into the later-described male terminal press-fit gap 22 of the female terminal 16, has a tapered shape (see FIG. 1). The male terminal 12 is electrically conductive and made of metal having a low electrical resistance such as copper, copper alloy, aluminum or aluminum alloy.

A pair of inclined portions 18, 18 are provided on both end parts in the plate width direction of the male terminal 12 by bending and inclining the both end parts in the plate width direction (lateral direction) of the flat metal fitting toward one side (upper side) in the plate thickness direction. That is, in the male terminal 12, the pair of inclined portions 18, 18 are provided on both sides in a direction intersecting the insertion direction (direction from front to rear) into the male terminal press-fit gap 22 to be described later, in the first embodiment, the plate width direction orthogonal to the insertion direction. A central flat portion 20 extending flat is provided in a central part in the plate width direction located between the pair of inclined portions 18, 18 in the plate width direction of the male terminal 12. Note that the pair of inclined portions 18, 18 may be provided over the entire length of the male terminal 12 or may be provided in the tip part in the insertion direction having the tapered shape in the male terminal 12 to be inserted into the male terminal press-fit gap 22. In the first embodiment, the plate thickness of the male terminal 12 is substantially constant, and each of the pair of inclined portions 18, 18 and the central flat portion 20 has a plate thickness A (see FIG. 3), but the thicknesses of the pair of inclined portions 18, 18 and the central flat portion 20 may be different.

Angles of inclination of the pair of inclined portions 18, 18 with respect to the central flat portion 20 are θ1 (see FIG. 3). Note that, in the first embodiment, the angle of inclination of the inclined portion 18 on one side (left side) in the plate width direction with respect to the central flat portion 20 and that of the inclined portion 18 on the other side (right side) in the plate width direction are equal to each other (θ1), but the angles of inclination on the both left and right sides may be different from each other.

The angles of inclination θ1 of the pair of inclined portions 18, 18 with respect to the central flat portion 20 are not limited, but preferably, for example, 5° or more and 45° or less, more preferably 10° or more and 30° or less. By setting the angles of inclination θ1 of the inclined portions 18 to 5° or more, an outward displacement of the male terminal 12 in the plate width direction can be suppressed also when an external force acting outward in the plate width direction is applied to the male terminal 12. By setting the angles of inclination θ1 of the inclined portions 18 to 45° or less, a vertical dimension of the male terminal 12 or consequently the terminal unit 10 can be suppressed to be small.

As described later, with the male terminal 12 press-fit and arranged in the male terminal press-fit gap 22 of the female terminal 16, a surface (upper surface) on one side in the plate thickness direction is arranged to face the first contact portion 28 of the male terminal 16 and a surface (lower surface) on the other side in the plate thickness direction is arranged to face the second contact portion 30 of the female terminal 16. In this way, the male terminal 12 is sandwiched by the first and second contact portions 28, 30 of the female terminal 16.

In the male terminal 12, a side (front side in FIG. 1) closer to a base end side than the tip part in the insertion direction having the tapered shape extends straight. For example, this side may extend to the base end side in a state shown in FIG. 1 with the pair of inclined portions 18, 18 provided or may extend to the base end side while having a substantially flat plate shape without the pair of inclined portions 18, 18 being provided. A wire is fixed to the base end side part of the male terminal 12, for example, by crimping, welding or the like, or a bolt insertion hole is provided in this part and this part is fixed to a terminal portion of a device.

### (Female Terminal 16)

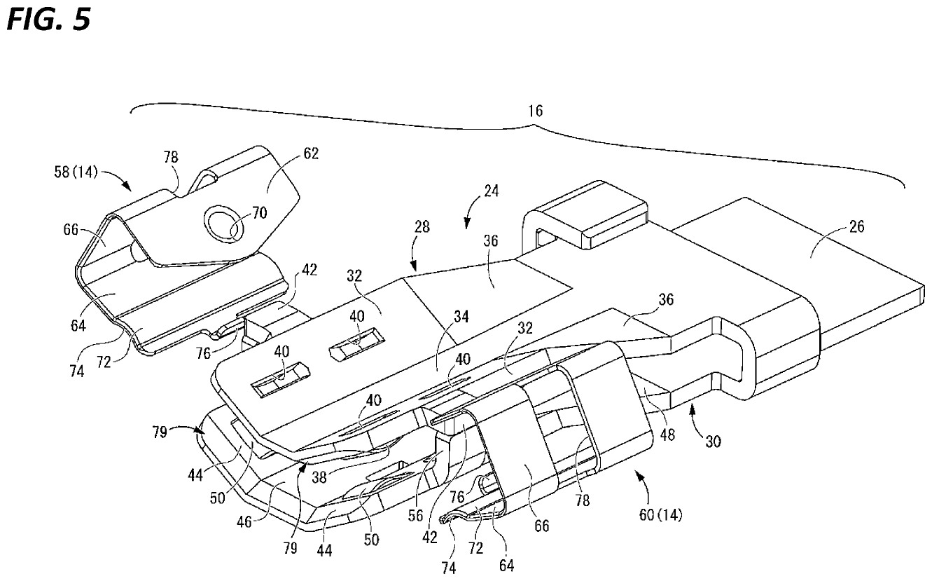

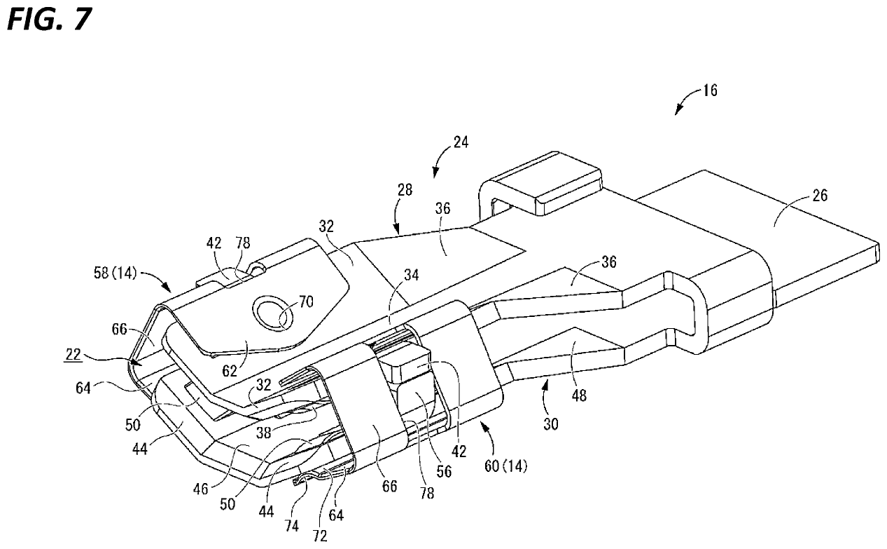

For example, as also shown in FIGS. 5 and 7, the female terminal 16 integrally includes a body portion 24 having the male terminal press-fit gap 22 open forward toward projecting end sides of the first and second contact portions 28, 30 to be described later inside and a wire connecting portion 26 to be fixed to a core wire of an unillustrated wire. More particularly, the female terminal 16 is electrically conductive and made of one of various metal materials, which can be press-worked and stamped, such as brass, copper, copper alloy, aluminum and aluminum alloy.

The male terminal press-fit gap 22 is provided between vertically facing surfaces of the first and second contact portions 28, 30 facing in the vertical direction. In short, the first and second contact portions 28, 30 are arranged to face each other across the male terminal press-fit gap 22. In a rear end part of the body portion 24, the first and second contact portions 28, 30 are coupled to each other and, for example, crimped and fixed, to prevent the first and second contact portions 28, 30 after press working from being separated from each other. In other words, end sides (rear end sides) in a longitudinal direction of the first and second contact portions 28, 30 are coupled in a base end part (rear end part) of the female terminal 16, and the first and second contact portions 28, 30 are cantilevered forward from this coupled base end part. Further, a rear end part of the second contact portion 30 extends further rearward than the coupled part to the first contact portion 28 to constitute the wire connecting portion 26 substantially in the form of a rectangular flat plate.

### (First Contact Portion 28)

The first contact portion 28 is substantially in the form of a rectangular flat plate as a whole and extends straight in a front-rear direction. In the first contact portion 28, a pair of inclined side edge parts 32, 32 are provided in both end parts in the plate width direction (lateral direction) by being bent and inclined toward the one side (upper side) in the plate thickness direction with respect to a central part in the plate width direction. That is, the pair of first inclined side edge parts 32, 32 are facing the surface (upper surface) on the one side in the plate thickness direction of the male terminal 12 and respectively inclined along the pair of inclined portions 18, 18. The central part in the plate width direction of the first contact portion 28 located between this pair of first inclined side edge parts 32, 32 in the plate width direction is a first flat portion 34 facing the central flat portion 20 of the male terminal 12 and extending flat.

In the first embodiment, each first inclined side edge part 32 is provided over a predetermined length from the front end of the first contact portion 28. Each first inclined side edge part 32 is inclined at a predetermined angle of inclination θ2 (see FIG. 3) with respect to the first flat portion 34 in a front end part of the first contact portion 28. Note that, in the first embodiment, the angle of inclination of the first inclined side edge part 32 on one side (left side) in the plate width direction with respect to the first flat portion 34 and that of the first inclined side edge part 32 on the other side (right side) in the plate width direction with respect to the first flat portion 34 are equal to each other (θ2) in the first contact portion 28, but the angles of inclination on the both left and right sides may be different from each other.

Rear end parts of the both end parts in the lateral direction of the first contact portion 28 are not provided with the respective first inclined side edge parts 32, extend flat with respect to the first flat portion 34 and have an angle of inclination of 0 with respect to the first flat portion 34. That is, transition portions 36 in which the angle of inclination with respect to the first flat portion 34 gradually changes in the front-rear direction are provided in intermediate parts in the front-rear direction of the both end parts in the lateral direction of the first contact portion 28. The angle of inclination with respect to the first flat portion 34 is θ2 in a front end part of each transition portion 36. Therefore, in each transition portion 36, the angle of inclination with respect to the first flat portion 34 gradually decreases from θ2 to 0 from front to rear. In short, in the both end parts in the lateral direction of the first contact portion 28, parts in front of the respective transition portions 36 are bent upward with respect to the first flat portion 34. Front parts of the first contact portion 28 having the constant angle of inclination θ2 are the respective first inclined side edge parts 32.

First contact point portions 38 projecting toward the male terminal press-fit gap 22 located below are provided on the inner surface (lower surface) of each first inclined side edge part 32. These first contact point portions 38 project in the plate thickness direction of each first inclined side edge part 32, and obliquely project with respect to the vertical direction, which is the plate thickness direction of the first flat portion 34. The first contact point portion 38 has a laterally long flat shape having a dimension in the lateral direction larger than a dimension in the front-rear direction and, as also shown in FIGS. 5 and 7, a projecting end surface is a curved surface. In the first embodiment, the first contact point portions 38 are provided at two positions separated in the front-rear direction, which is the insertion direction of the male terminal 12, on each first inclined side edge part 32, and a total of four first contact point portions 38 are provided on the first contact portion 28. Recesses 40 open upward are formed at positions corresponding to the respective first contact point portions 38 in the outer surface (upper surface) of each first inclined side edge part 32. The respective first contact point portions 38 are formed by press-working the first contact portion 28.

Further, each first inclined side edge part 32 is provided with an abutting portion 42 for coming into contact with an abutted portion 56 to be described later when the spring member 14 (first spring member 58 or second spring member 60 to be described later) is assembled. A pair of these abutting portions 42, 42 project outward in the lateral direction, which is the plate width direction, from both lateral end parts (i.e. upper end parts) of the respective first inclined side edge parts 32. In the first embodiment, these abutting portions 42 are provided in intermediate parts in the front-rear direction of the respective first inclined side edge parts 32. Particularly, in the first embodiment, these abutting portions 42 are provided at positions corresponding to parts between the respective first contact point portions 38 separated in the front-rear direction.

### (Second Contact Portion 30)

The second contact portion 30 is substantially in the form of a rectangular flat plate as a whole and extends straight in the front-rear direction. In the second contact portion 30, a pair of inclined side edge parts 44, 44 are provided in both end parts in the plate width direction (lateral direction) by being bent and inclined toward the one side (upper side) in the plate thickness direction with respect to a central part in the plate width direction. That is, the pair of second inclined side edge parts 44, 44 are facing the surface (lower surface) on the other side in the plate thickness direction of the male terminal 12 and respectively inclined along the pair of inclined portions 18, 18. The central part in the plate width direction of the second contact portion 30 located between this pair of second inclined side edge parts 44, 44 in the plate width direction is a second flat portion 46 facing the central flat portion 20 of the male terminal 12 and extending flat. In short, the first and second inclined side edge parts 32, 44 facing each other in the vertical direction are respectively provided on the one side (left side) and the other side (right side) in the plate width direction of the first and second contact portions 28, 30.

In the first embodiment, each second inclined side edge part 44 is provided over a predetermined length from the front end of the second contact portion 30. Each second inclined side edge part 44 is inclined at a predetermined angle of inclination θ3 (see FIG. 3) with respect to the second flat portion 46 in a front end part of the second contact portion 30. Note that, in the first embodiment, the angle of inclination of the second inclined side edge part 44 on the one side (left side) in the plate width direction with respect to the second flat portion 46 and that of the second inclined side edge part 44 on the other side (right side) in the plate width direction with respect to the second flat portion 46 are equal to each other (θ3), but the angles of inclination on the both left and right sides may be different from each other.

The angle of inclination θ2 of each first inclined side edge part 32 with respect to the first flat portion 34 is preferably equal to the angle of inclination θ1 of each inclined portion 18 with respect to the central flat portion 20 in the male terminal 12 or within an angle difference range of 10° or less even if these angles of inclination are different. In this way, the rattling of the male terminal 12 in the male terminal press-fit gap 22 can be suppressed and contact areas of the male terminal 12 and the first contact point portions 38 can be stably ensured in press-fitting the male terminal 12 into the male terminal press-fit gap 22. Similarly, the angle of inclination θ3 of each second inclined side edge part 44 with respect to the second flat portion 46 is preferably equal to the angle of inclination θ1 of each inclined portion 18 with respect to the central flat portion 20 in the male terminal 12 or within an angle difference range of 10° or less even if these angles of inclination are different. In this way, the rattling of the male terminal 12 in the male terminal press-fit gap 22 can be suppressed and contact areas of the male terminal 12 and second contact point portions 50 to be described later can be stably ensured in press-fitting the male terminal 12 into the male terminal press-fit gap 22.

In the first embodiment, the angle of inclination θ2 of each first inclined side edge part 32 with respect to the first flat portion 34 and the angle of inclination θ3 of each second inclined side edge part 44 with respect to the second flat portion 46 are substantially equal. Thus, in the first embodiment, the first and second inclined side edge parts 32, 44 on the left side extend substantially in parallel and the first and second inclined side edge parts 32, 44 on the right side extend substantially in parallel.

Further, similarly to the first contact portion 28, rear end parts of both end parts in the lateral direction of the second contact portion 30 extend flat with respect to the second flat portion 46, and transition portions 48, in which the angle of inclination with respect to the second flat portion 46 gradually changes in the front-rear direction, are provided in the intermediate parts in the front-rear direction of the both end parts in the lateral direction of the second contact portion 30. That is, a front part of the second contact portion 30 having the constant angle of inclination θ3 with respect to the second flat portion 46 is each second inclined side edge part 44.

The second contact point portions 50 projecting toward the male terminal press-fit gap 22 located above are provided on the inner surfaces (upper surfaces) of the respective second inclined side edge parts 44. These second contact point portions 50 project in the plate thickness directions of the respective second inclined side edge parts 44, and obliquely project with respect to the vertical direction, which is the plate thickness direction of the second flat portion 46. The second contact point portion 50 has a laterally long flat shape having a dimension in the lateral direction larger than a dimension in the front-rear direction similarly to the first contact point portion 38 and, as also shown in FIGS. 5 and 7, a projecting end surface is a curved surface. In the first embodiment, the second contact point portions 50 are provided at two positions separated in the front-rear direction, which is the insertion direction of the male terminal 12, on each second inclined side edge part 44, and a total of four second contact point portions 50 are provided on the second contact portion 30.

Particularly, in the first embodiment, the second contact point portions 50 are provided at positions corresponding to the first contact point portions 38 in the vertical direction, and the first and second contact point portions 38, 50 overlap each other in projection in the vertical direction. Further, in the projection of the respective first inclined side edge parts 32 and the respective second inclined side edge parts 44 in the plate thickness direction, the first and second contact point portions 38, 50 are shifted in position and partially overlap.

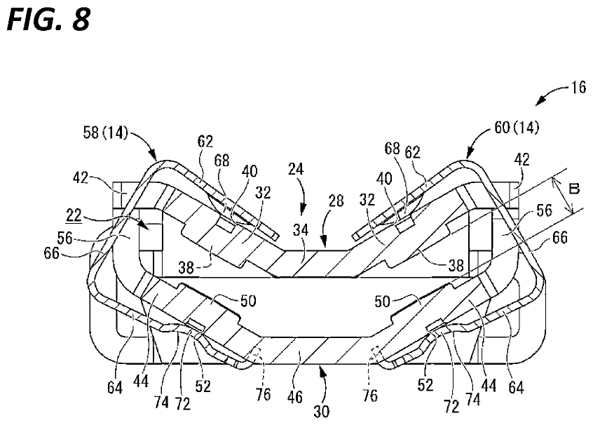

Top parts of the first contact point portions 38 and those of the second contact point portions 50 linearly extend in an oblique direction inclined upward from an inner side toward an outer side in the lateral direction, the top parts of the first contact point portions 38 and those of the second contact point portions 50 on the left side extend in parallel to each other, and the top parts of the first contact point portions 38 and those of the second contact point portions 50 on the right side extend in parallel to each other. In a state of FIGS. 7 and 8 where the spring members 14 (first spring member 58 and second spring member 60 to be described later) are assembled with the body portion 24 of the female terminal 16, a separation distance between the top parts of the first contact point portions 38 and those of the second contact point portions 50 is B (see FIG. 8). The separation distance B between the top part of the first contact point portion 38 and that of the second contact point portion 50 is smaller than the plate thickness A of the male terminal 12 (B<A), whereby the male terminal 12 is press-fit into the male terminal press-fit gap 22.

Recesses 52 open downward are formed at positions corresponding to the respective second contact point portions 50 in the outer surface (lower surface) of each second inclined side edge part 44. The respective second contact point portions 50 are formed by press-working the second contact portion 30. Further, engaged portions 54 to be locked by locking claws 76 of the spring members 14 (first spring member 58 and second spring member 60) to be described later are provided to be open downward in the lower surface of the second contact portion 30. In the first embodiment, the engaged portion 54 is formed as a through hole penetrating through the second contact portion 30 in the plate thickness direction. Note that this engaged portion may also be a bottomed hole open downward. Further, in the first embodiment, a pair of the engaged portions 54, 54 are provided apart from each other on both sides in the lateral direction, which are both sides in the plate width direction, and provided in connected parts of the second flat portion 46 and the respective second inclined side edge parts 44. Particularly, in the first embodiment, the respective engaged portions 54 are provided at positions in the front-rear direction between the respective second contact point portions 50 separated in the front-rear direction.

Further, the respective second inclined side edge parts 44 are provided with the abutted portions 56 projecting outward in the lateral direction, which is the plate width direction, and projecting upward toward the respective inclined side edge parts 32 from projecting end parts thereof. This pair of abutted portions 56, 56 are provided in intermediate parts in the front-rear direction of the respective second inclined side edge parts 44. In the first embodiment, the abutted portions 56, 56 are provided at positions in the front-rear direction between the respective second contact point portions 50 separated in the front-rear direction. That is, the respective abutted portions 56 are provided to face the respective abutting portions 42 on the respective first inclined side edge parts 32 in the vertical direction, and the respective abutted portions 56 and the respective abutting portions 42 come into contact with each other when the spring members 14 (first spring member 58 and second spring member 60) to be described later are assembled.

### (Spring Members 14)

The spring members 14 are assembled with the body portion 24 of the female terminal 16. The spring members 14 include the first spring member 58 to be arranged on one side (left side) in the lateral direction, which is the plate width direction of (the flat metal fitting constituting) the male terminal 12 and the second spring member 60 to be arranged on the other side (right side) in the lateral direction. Note that, in the first embodiment, the first and second spring members 58, 60 have the same shape and are used while being laterally inverted from each other. Thus, in the following description, the first spring member 58 is described and the second spring member 60 is denoted using the same reference signs as the first spring member 58 in figures and not described.

### (First Spring Member 58 (Second Spring Member 60))

The first spring member 58 is constituted by a leaf spring clip including a first plate portion 62 to be overlapped on the outer surface (upper surface) of the first inclined side edge part 32, a second plate portion 64 to be overlapped on the outer surface (lower surface) of the second inclined side edge part 44 and a coupling plate portion 66 coupling these first and second plate portions 62, 64. The first spring member 58 is, for example, made of metal which can be press-worked, and can be formed by bending a metal flat plate into a predetermined shape.

The first and second plate portions 62, 64 respectively extend toward one side in a plate thickness direction of the coupling plate portion 66 from upper and lower ends of the coupling plate portion 66, and are facing each other in the vertical direction while being spaced apart by a predetermined distance. These first and second plate portions 62, 64 are resiliently deformable in directions away from or toward each other with connected parts to the coupling plate portion 66 as base points.

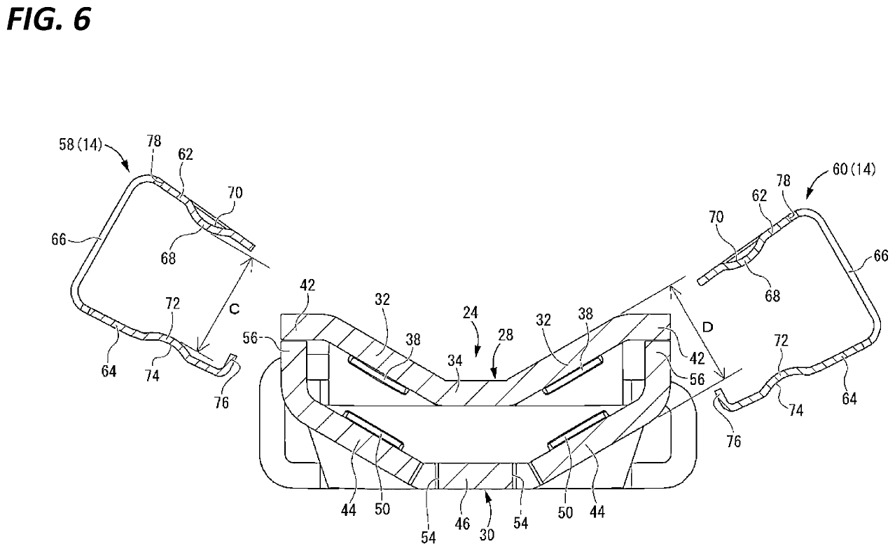

As also shown in FIGS. 5 and 6, the first plate portion 62 is in the form of a flat plate having a substantially rectangular or pentagonal shape, and a first protrusion 68 projecting inward in a direction facing the second plate portion 64 (downward). In the first embodiment, the first protrusion 68 has a hemispherical shape, and a recess 70 open upward is formed at a position corresponding to the first protrusion 68 in the upper surface of the first plate portion 62. In this way, the first protrusion 68 can be formed by press-working. Since the first protrusion 68 has the hemispherical shape, a top part of the first protrusion 68 comes into point contact with the outer surface of the first inclined side edge part 32 and applies a biasing force to the first inclined side edge part 32 in a concentrated manner when the first plate portion 62 is overlapped on the outer surface of the first inclined side edge part 32.

Further, the second plate portion 64 is in the form of a flat plate having a substantially rectangular shape, and a second protrusion 72 continuously extending in a width direction of the second plate portion 64 (i.e. the front-rear direction, which is the insertion direction of the male terminal 12) while having an arcuate cross-section convex toward the first plate portion 62 is provided in an intermediate part in a length direction (lateral direction) of the second plate portion 64. In the first embodiment, the second protrusion 72 is provided over an entire length in the width direction of the second plate portion 64, and the first protrusion 68 projects toward an intermediate part in an extending direction of the second protrusion 72. A recess 74 open downward is formed at a position corresponding to the second protrusion 72 in the lower surface of the second plate portion 64. In this way, the second protrusion 72 can be formed by press-working. Since the second protrusion 72 is shaped to linearly extend while having an arcuate cross-section, a top part of the second protrusion 72 comes into line contact with the outer surface of the second inclined side edge part 44 and applies a biasing force to the second inclined side edge part 44 in a concentrated manner when the second plate portion 64 is overlapped on the outer surface of the second inclined side edge part 44. Note that a locking claw 76 projecting toward the facing first plate portion 62 and the male terminal press-fit gap 22 in the female terminal 16 (upward) is provided in a central part in the front-rear direction of a projecting end part of the second plate portion 64.

In a single state (natural state) of the first spring member 58 before being assembled with the body portion 24 of the female terminal 16, a separation distance between the top part of the first protrusion 68 and that of the second protrusion 72 is C (see FIG. 6). Note that the separation distance C between the top part of the first protrusion 68 and that of the second protrusion 72 mentioned here is not a linear distance connecting the top part of the first protrusion 68 and that of the second protrusion 72, but a separation distance in the plate thickness direction between the first and second inclined side edge parts 32, 44. Further, before the first spring member 58 is assembled with the body portion 24 of the female terminal 16, a separation distance between the outer surface (upper surface) of the first inclined side edge part 32 and the outer surface (lower surface) of the second inclined side edge part 44 is D (see FIG. 6). In the state before the first spring member 58 is assembled with the body portion 24 of the female terminal 16, the separation distance C between the top part of the first protrusion 68 and that of the second protrusion 72 is smaller than the separation distance D between the outer surface of the first inclined side edge part 32 and that of the second inclined side edge part 44 (C<D).

In this way, when the first spring member 58 is assembled with the body portion 24 as described later, biasing forces by the first spring member 58 are applied to the first and second inclined side edge parts 32, 44 and the first and second inclined side edge parts 32, 44 are biased in the directions toward each other by the first spring member 58. Note that since the first and second spring members 58, 60 are respectively assembled on both left and right sides of the body portion 24, the first spring member 58 biases the first and second inclined side edge parts 32, 44 on the one side (left side) in the plate width direction in the directions toward each other, and the second spring member 60 biases the first and second inclined side edge parts 32, 44 on the other side (right side) in the plate width direction in the directions toward each other.

Further, a through hole 78 penetrating in the plate thickness direction is formed in a central part in the front-rear direction of the coupling plate portion 66. In the first embodiment, the through hole 78 is formed to extend over an entire length in a length direction of the coupling plate portion 66 (facing direction of the first and second plate portions 62, 64) and have a predetermined width (dimension in the front-rear direction). This through hole 78 is formed at a position corresponding to the abutting portion 42 and the abutted portion 56 in the first and second contact portions 28, 30. When the first spring member 58 is assembled with the body portion 24 of the female terminal 16, the abutting portion 42 and the abutted portion 56 are inserted into the through hole 78 and project outward in the plate thickness direction of the coupling plate portion 66. As described above, since the first and second spring members 58, 60 are respectively assembled on the both left and right sides of the body portion 24, the abutting portion 42 and the abutted portion 56 on the one side (left side) in the plate width direction of the first and second contact portions 28, 30 are inserted into the through hole 78 of the first spring member 58 and the abutting portion 42 and the abutted portion 56 on the other side (right side) in the plate width direction of the first and second contact portions 28, 30 are inserted into the through hole 78 of the second spring member 60.

### (Assembly Process of Terminal Unit 10)

Next, a specific example of an assembly process of the terminal unit 10 is described. Note that the assembly process of the terminal unit 10 is not limited to that described below.

First, the metal flat plate for constituting the body portion 24 of the female terminal 16 is prepared and formed into a predetermined shape by press-working, whereby the body portion 24 integrally provided with the wire connecting portion 26 is formed. Note that, in a state before the first and second spring members 58, 60 are assembled, the abutting portions 42 and the abutted portions 56 need not be in contact in the body portion 24 and may be facing each other in the vertical direction while being separated by a short or predetermined distance. As described above, the separation distance D between the outer surface of the first inclined side edge part 32 and that of the second inclined side edge part 44 may be set larger than the separation distance C between the top part of the first protrusion 68 and that of the second protrusion 72. Further, the metal flat plate for constituting the first spring member 58 is prepared and formed into a predetermined shape by press-working, whereby the first spring member 58 is formed. Note that since the first and second spring members 58, 60 have the same shape, the second spring member 60 is formed simultaneously with the first spring member 58.

After the body portion 24 of the female terminal 16 and the first and second spring members 58, 60 are arranged as shown in FIGS. 5 and 6, the first and second spring members 58, 60 are expanded and deformed, the first plate portions 62 are overlapped on the outer surfaces of the first inclined side edge parts 32 and the second plate portions 64 are overlapped on the outer surfaces of the second inclined side edge parts 44. Thereafter, these first and second spring members 58, 60 are respectively slid and displaced inward in the lateral direction, and the respective locking claws 76 provided on the respective second plate portions 64 in the first and second spring members 58, 60 are locked to the respective engaged portions 54 open downwardly of the second contact portion 30. At that time, the abutting portions 42 and the abutted portions 56 in the body portion 24 are inserted into the respective through holes 78 of the respective coupling plate portions 66 in the first and second spring members 58, 60 and caused to project outward in the plate thickness direction of each coupling plate portion 66. In this way, the first and second spring members 58, 60 are assembled with the body portion 24 of the female terminal 16 inseparably in the lateral direction, which is the plate width direction, and the female terminal 16 is completed.

In a completed state of the female terminal 16, the respective first protrusions 68 of the respective first plate portions 62 of the first and second spring members 58, 60 are in point contact with parts of the outer surfaces of the first inclined side edge parts 32 between the recesses 40, 40 separated in the front-rear direction. Further, as shown in FIG. 8, the respective second protrusions 72 on the respective second plate portions 64 of the first and second spring members 58, 60 are arranged at positions corresponding to the formation positions of the respective recesses 52 on the outer surfaces of the second inclined side edge parts 44. In this way, the respective second protrusions 72 of the first and second spring members 58, 60 are in line contact with parts of the outer surfaces of the second inclined side edge parts 44 between the recesses 52, 52 separated in the front-rear direction and outward of the respective recesses 52 in the front-rear direction.

Here, since the separation distance D between the outer surface of the first inclined side edge part 32 and that of the second inclined side edge part 44 is set larger than the separation distance C between the top part of the first protrusion 68 and that of the second protrusion 72 in the first and second spring members 58, 60 in the natural state, the first and second spring members 58, 60 are assembled with the body portion 24 with the first and second plate portions 62, 64 expanded more than in the natural state. In this way, resilient restoring forces of the first and second plate portions 62, 64 are applied as biasing forces to the first and second inclined side edge parts 32, 44 in the directions toward each other. As a result, the respective abutting portions 42 of the first contact portion 28 and the respective abutted portions 56 of the second contact portion 30 come into contact with each other to limit any further displacement of the first and second inclined side edge parts 32, 44 in the approaching directions.

Particularly, in a state where approaching displacements of the first and second contact portions 28, 30 are limited by the contact of the abutting portions 42 and the abutted portions 56, the resilient restoring forces of the first and second plate portions 62, 64 are applied to the respective first inclined side edge parts 32 and the respective second inclined side edge parts 44. In this way, in the female terminal 16 in the completed state, biasing forces are constantly applied to the first and second inclined side edge parts 32, 44 in the approaching directions by the first and second spring members 58, 60. In the completed state of the female terminal 16, the separation distance between the top of the first contact point portion 38 and that of the second contact point portion 50 is B as described above.

Subsequently, the male terminal 12 prepared separately is inserted from front into the male terminal press-fit gap 22 of the female terminal 16 in the completed state. Here, the separation distance B between the top part of the first contact point portion 38 and that of the second contact point portion 50 in the female terminal 16 is smaller than the plate thickness of the male terminal 12. To enable the male terminal 12 to be smoothly inserted into the male terminal press-fit gap 22, guiding tapers 79, 79 for gradually increasing a distance between the facing surfaces of the first and second contact portions 28, 30 of the female terminal 16 toward the front are respectively provided over the entire lengths in the plate width direction of the first and second contact portions 28, 30 (see FIG. 5). In this way, the male terminal 12 is press-fit and inserted into the male terminal press-fit gap 22. That is, the respective first contact point portions 38 of the first contact portion 28 contact the respective inclined portions 18 of the male terminal 12 from above and the respective second contact point portions 50 of the second contact portion 30 contact the respective inclined portions 18 from below. The respective first contact point portions 38 and the respective second contact point portions 50 are pushed wider apart against the biasing forces of the first and second spring members 58, 60 by the male terminal 12, and the first and second contact portions 28, 30 are displaced in directions separating from each other. In this way, the male terminal 12 can be press-fit into the male terminal press-fit gap 22 and, as shown in FIGS. 1 to 4, the male terminal 12 and the female terminal 16 are fit to complete the terminal unit 10.

In the terminal unit 10 in which the male terminal 12 and the female terminal 16 are fit, the respective first plate portions 62 and the respective second plate portions 64 of the first and second spring members 58, 60 are pushed and expanded more than in the natural state and the resilient restoring forces of the respective first plate portions 62 and the respective second plate portions 64 are applied as the biasing forces to the respective first and second inclined side edge parts 32, 44 in the directions toward each other. In this way, the respective first contact point portions 38 of the respective first inclined side edge parts 32 are pressed against the respective inclined portions 18 of the male terminal 12 from above, and the respective second contact point portions 50 of the respective second inclined side edge parts 44 are pressed against the respective inclined portions 18 of the male terminal 12 from below. Particularly, in the female terminal 16 before the insertion of the male terminal 12, biasing forces by the first and second spring members 58, 60 are applied to the respective first inclined side edge parts 32 and the respective second inclined side edge parts 44 in advance and, in addition to these biasing forces, biasing forces generated as the first and second contact portions 28, 30 are pushed wider apart in the directions separating from each other by the male terminal 12 are applied to the respective first inclined side edge parts 32 and the respective second inclined side edge parts 44. Thus, the respective inclined portions 18 are reliably pressed by the respective first contact point portions 38 and the respective second contact point portions 50.

That is, on the left side (one side in the plate width direction) of the terminal unit 10, the first contact point portions 38 of the first inclined side edge part 32 and the second contact point portions 50 of the second inclined side edge part 44 are pressed against the inclined portion 18 of the male terminal 12 press-fit between those contact point portions by biasing forces of the first spring member 58. Further, on the right side (other side in the plate width direction) of the terminal unit 10, the first contact point portions 38 of the first inclined side edge part 32 and the second contact point portions 50 of the second inclined side edge part 44 are pressed against the inclined portion 18 of the male terminal 12 press-fit between those contact point portions by biasing forces of the second spring member 60.

In the first embodiment, both a pressing force F1 (see FIG. 3) by the first contact point portion 38 and a pressing force F2 (see FIG. 3) by the second contact point portion 50 act in the same direction as the plate thickness direction of each inclined portion 18. Thus, each inclined portion 18 is stably sandwiched by the first and second contact point portions 38, 50 and the male terminal 12 and the female terminal 16 can be more reliably made conductive. Particularly, in the first embodiment, an acting direction of the pressing force F1 by the first contact point portion 38 and that of the pressing force F2 by the second contact point portion 50 are not facing each other along the plate thickness direction of each inclined portion 18. Specifically, the pressing forces F1 by the first contact point portions 38 act on both end parts in the lateral direction of each inclined portion 18, but the pressing forces F2 by the second contact point portions 50 act on parts laterally inward of the parts where the pressing forces F1 act. In this way, it is avoided that the pressing forces F1, F2 from both upper and lower sides act at the same positions in each inclined portion 18. As a result, since the first and second contact point portions 38, 50 are pushed wider apart at a plurality of positions by each inclined portion 18 of the male terminal 12, insertion resistance can be reduced.

Further, as shown in FIG. 3, the pressing force F1 by the first contact point portion 38 acts as a downward force component Fla and a laterally outward force component F1b, and the pressing force F2 by the second contact point portion 50 acts as an upward force component F2a and a laterally inward force component F2b. Here, for example, if an external force is applied to the male terminal 12 from one side toward the other (e.g. from right to left) in the lateral direction, a displacement of the male terminal 12 according to the applied external force is suppressed by the force component in an opposite direction (e.g. force component F1b acting from left to right) and the laterally inward force component F2b. Particularly, since the downward force component Fla by the first contact point portion 38 and the upward force component F2a by the second contact point portion 50 are opposed to each other in the vertical direction, a displacement of the male terminal 12 in the vertical direction is also more reliably suppressed. As a result, a displacement of the male terminal 12 with respect to the female terminal 16 is suppressed and an electrically conductive state of the male terminal 12 and the female terminal 16 can be stably maintained.

Particularly, the spring members 14 for applying these pressing forces F1, F2 are divided as the first spring member 58 arranged on the left side and the second spring member 60 arranged on the right side. In this way, the pressing forces F1, F2 on the left side can be obtained from the first spring member 58, and the pressing forces F1, F2 on the right side can be obtained from the second spring member 60. Therefore, the pressing forces F1, F2 acting in different directions can be obtained separately on the left and right sides while the miniaturization of the spring members 14 (first spring member 58 and the second spring member 60) is achieved.

Further, since each first inclined side edge part 32 and each second inclined side edge part 44 are provided along each inclined portion 18, contact areas of the respective first and second contact point portions 38, 50 provided on the first and second inclined side edge parts 32, 44 and each inclined portion 18 can be stably ensured, and continuity resistance between the female and male terminals 16, 12 is reduced.

The male terminal 12 includes the central flat portion 20 in the lateral center and the pair of inclined portions 18, 18 on the both left and right sides. Similarly, the first contact portion 28 includes the first flat portion 34 in the lateral center and the pair of first inclined side edge parts 32, 32 on the both left and right sides, and the second contact portion 30 includes the second flat portion 46 in the lateral center and the pair of second inclined side edge parts 44, 44 on the both left and right sides. That is, in the first embodiment, the male terminal 12 and the first and second contact portions 28, 30 have similar shapes, and the male terminal 12 can be inserted into the male terminal press-fit gap 22 provided between the first and second contact portions 28, 30 with good space efficiency.

With the first and second spring members 58, 60 assembled with the body portion 24 of the female terminal 16, displacements of the first and second contact portions 28, 30 in the approaching directions are prevented by the contact of the abutting portions 42 and the abutted portions 56. In this way, it is avoided that the separation distance between the top of the first contact point portion 38 and that of the second contact point portion 50 becomes smaller than B in the male terminal press-fit gap 22, and it is suppressed that insertion resistance becomes excessively large in inserting the male terminal 12 into the male terminal press-fit gap 22. Particularly, in the first embodiment, since the pair of abutting portions 42 and the pair of abutted portions 56 are provided on the both left and right sides, an effect of preventing the displacements of the first and second contact portions 28, 30 in the approaching directions is more reliably exhibited.

Since the first and second spring members 58, 60 are both constituted by leaf spring clips, the structures of the first and second spring members 58, 60 and, consequently, the structure of the terminal unit 10 can be simplified. Particularly, since the first plate portions 62 and the second plate portions 64 in the first and second spring members 58, 60 are respectively overlapped on the first inclined side edge parts 32 and the second inclined side edge parts 44, the terminal unit 10 is also reduced in size.

In the first embodiment, the pair of first inclined side edge parts 32 are provided on the both left and right sides of the first contact portion 28 and the pair of second inclined side edge parts 44 are provided on the both left and right sides of the second contact portion 30 in the female terminal 16, and the space between these first and second contact portions 28, 30 facing each other serves as the male terminal press-fit gap 22 open forward. In this way, the female terminal 16 and the terminal unit 10 can be configured to have a relatively simple shape.

Each of the first and second spring members 58, 60 is provided with the locking claw 76, and the locking claw 76 is locked to the corresponding engaged portion 54 in the second contact portion 30. In this way, the first and second spring members 58, 60 are prevented from being displaced outward in the lateral direction with respect to the body portion 24. Further, each of the first and second spring members 58, 60 is provided with the through hole 78, and the abutting portions 42 and the abutted portions 56 of the first and second contact portions 28, 30 are inserted into these through holes 78. In this way, the first and second spring members 58, 60 are prevented from being displaced in the front-rear direction with respect to the body portion 24. As a result, accidental detachment of the first and second spring members 58, 60 from the female terminal 16 is prevented, and desired pressing forces F1, F2 by the first and second spring members 58, 60 can be stably obtained even if the male terminal 12 is repeatedly inserted into and withdrawn from the female terminal 16.

The plurality of first contact point portions 38 are separated in the front-rear direction on each first inclined side edge part 32, and the plurality of second contact point portions 50 are separated in the front-rear direction on each second inclined side edge part 44. In this way, the contact areas of the male terminal 12 and the first and second contact point portions 38, 50 can be stably ensured while plating wear and the like in press-fitting the male terminal 12 between the first and second contact point portions 38, 50 are suppressed. Further, since the male terminal 12 is held at a plurality of positions of the respective first and second inclined side edge parts 32, 44, a displacement of the male terminal 12 with respect to the female terminal 16 can be more stably suppressed. Particularly, a displacement of the male terminal 12 can be suppressed not only in the plate width direction, but also in a rotation direction with respect to the female terminal 16 by separating the plurality of first and second contact point portions 38, 50 in the front-rear direction.

The first and second plate portions 62, 64 of each of the first and second spring members 58, 60 are respectively provided with the first protrusion 68 having a hemispherical shape and the second protrusion 72 linearly extending while having an arcuate cross-section. In this way, each second protrusion 72 and each second inclined side edge part 44 can be held in line contact while each first protrusion 68 and each first inclined side edge part 38 are held in point contact. As a result, it is possible to achieve an effect of improving ease of assembly in assembling the first and second spring members 58, 60 on the body portion 24 of the female terminal 16 and an effect of biasing the first and second inclined side edge parts 32, 44 by the first and second plate portions 62, 64. Further, by arranging each second protrusion 72 on the respective recesses 52 in each second inclined side edge part 44 as in the first embodiment, each second protrusion 72 can be brought into contact with each second inclined side edge part 44 at a plurality of positions in the front-rear direction and an effect of suppressing displacements of the first and second spring members 58, 60 with respect to the body portion 24 of the female terminal 16 can be improved. Furthermore, since the first protrusions 68 have a hemispherical shape, the male terminal 12 can be stably biased even if the male terminal 12 is press-fit into the male terminal press-fit gap 22 and the first and second contact portions 28, 30 of the female terminal 16 are inclined about the base end part.

### Second Embodiment

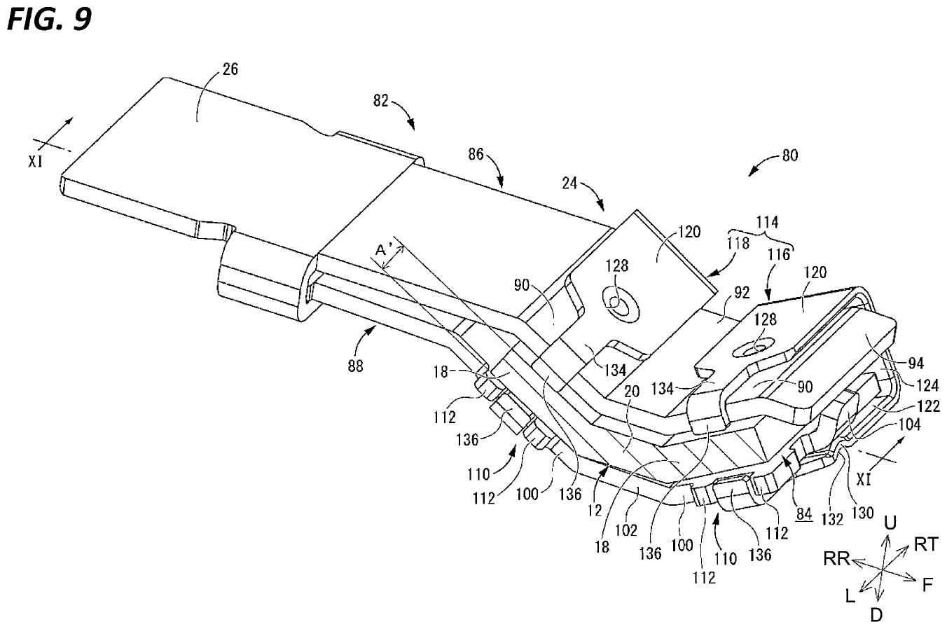

Next, a terminal unit 80 of a second embodiment of the present disclosure is described using FIGS. 9 to 11. Although the male terminal 12 is press-fit into the female terminal 16 in the front-rear direction (direction from front to rear), which is a longitudinal direction, in the first embodiment, a male terminal 12 is press-fit into a female terminal 82 in the lateral direction (direction from left to right), which is a direction orthogonal to the longitudinal direction, in the second embodiment. Note that only a tip part of the male terminal 12 extending in the lateral direction is shown for easy viewing in FIG. 9. Further, in the following description, substantially the same members and parts as those of the first embodiment are denoted in figures by the same reference signs as in the first embodiment and are not described in detail.

The male terminal 12 has a structure similar to that of the first embodiment and is provided with a pair of inclined portions 18, 18 on both end parts in the plate width direction (front-rear direction), which is a direction intersecting a press-fitting direction, and a central flat portion 20 extending flat in a central part in the plate width direction. That is, the pair of inclined portions 18, 18 are inclined upward toward one side in the plate thickness direction with respect to the central flat portion 20.

### (Female Terminal 82)

The female terminal 82 is provided with a body portion 24 including a male terminal press-fit gap 84 inside and a wire connecting portion 26 behind the body portion 24 as in the first embodiment, but the male terminal press-fit gap 84 is open in one (left) side surface in the lateral direction of the female terminal 82 by assembling spring members 114 (first spring member 116 and second spring member 118) to be described later with the body portion 24 from the other side (right side) in the plate width direction (lateral direction). The male terminal press-fit gap 84 of the second embodiment is also provided between vertically facing surfaces of the first and second contact portions 86, 88 facing in the vertical direction. These first and second contact portions 86, 88 are coupled on one end side (rear end side) in the longitudinal direction at a base end part (rear end part) of the female terminal 82, and cantilevered from this coupled base end part. The male terminal press-fit gap 84 is provided on the other end sides (front end sides) in the longitudinal direction of the first and second contact portions 86, 88, which are free ends.

### (First Contact Portion 86)

The first contact portion 86 is substantially in the form of a rectangular flat plate as a whole and extends straight in the front-rear direction. In the first contact portion 86, a first inclined side edge part 90 inclined along the inclined portion 18 on one side (front side) in the plate width direction of the male terminal 12 is provided on a tip part (front end part) in a projecting direction (direction from rear to front). Further, in the first contact portion 86, a first inclined side edge part 90 inclined along the inclined portion 18 on the other side (rear side) in the plate width direction of the male terminal 12 is provided on a side closer to a base end side (rear end side) than the projecting tip part. This pair of first inclined side edge parts 90, 90 are separated from each other in the front-rear direction and a first flat portion 92 extending along the central flat portion 20 of the male terminal 12 is provided between the pair of first inclined side edge parts 90, 90. That is, the pair of first inclined side edge parts 90, 90 are inclined upward toward the one side in the plate thickness direction with respect to the first flat portion 92. Note that, a part of the first contact portion 86 behind the rear first inclined side edge part 90 extends flat in the front-rear direction, is coupled to the second contact portion 88 at a base end part (rear end part) and extends further rearward than the base end part coupled to the second contact portion 88 to constitute the wire connecting portion 26. Further, an abutting portion 94 projecting forward is provided on a front end part of the front first inclined side edge part 90.

First contact point portions 96 projecting toward the male terminal press-fit gap 84 located below are provided on the inner surface (lower surface) of each first inclined side edge part 90. These first contact point portions 96 project in the plate thickness direction of each first inclined side edge part 90. The first contact point portion 96 is shaped similarly to the first contact point portion 38 of the first embodiment, but has a dimension in the front-rear direction larger than a dimension in the lateral direction, and a projecting end surface is a curved surface. In the second embodiment, the first contact point portions 96 are provided at two positions separated in the lateral direction on each first inclined side edge part 90, and a total of four first contact point portions 96 are provided on the first contact portion 86. Recesses 98 open upward are formed at positions corresponding to the respective first contact point portions 96 in the outer surface (upper surface) of each first inclined side edge part 90.

### (Second Contact Portion 88)

The second contact portion 88 is substantially in the form of a rectangular flat plate as a whole and extends straight in the front-rear direction. In the second contact portion 88, a second inclined side edge part 100 inclined along the inclined portion 18 on one side (front side) in the plate width direction of the male terminal 12 is provided on a tip part (front end part) in a projecting direction (direction from rear to front). Further, in the second contact portion 88, a second inclined side edge part 100 inclined along the inclined portion 18 on the other side (rear side) in the plate width direction of the male terminal 12 is provided on a side closer to a base end side (rear end side) than the projecting tip part. This pair of second inclined side edge parts 100, 100 are separated from each other in the front-rear direction and a second flat portion 102 extending along the central flat portion 20 of the male terminal 12 is provided between the pair of second inclined side edge parts 100, 100. That is, the pair of second inclined side edge parts 100, 100 are inclined upward toward the one side in the plate thickness direction with respect to the second flat portion 102. Note that, a part of the second contact portion 88 behind the rear second inclined side edge part 100 extends flat in the front-rear direction and is coupled to the first contact portion 86 at the base end part (rear end part). Further, an abutted portion 104 projecting upward is provided on a central part in the lateral direction of a front end part of the front second inclined side edge part 100.

Second contact point portions 106 projecting toward the male terminal press-fit gap 84 located above are provided on the inner surface (lower surface) of each second inclined side edge part 100. These second contact point portions 106 project in the plate thickness direction of each second inclined side edge part 100. The second contact point portion 106 is shaped similarly to the first contact point portion 96 of the first inclined side edge part 90. These second contact point portions 106 are provided at two positions separated in the lateral direction on each second inclined side edge part 100, and a total of four second contact point portions 106 are provided on the second contact portion 88. Recesses 108 open downward are formed at positions corresponding to the respective second contact point portions 106 in the outer surface (upper surface) of each second inclined side edge part 100.

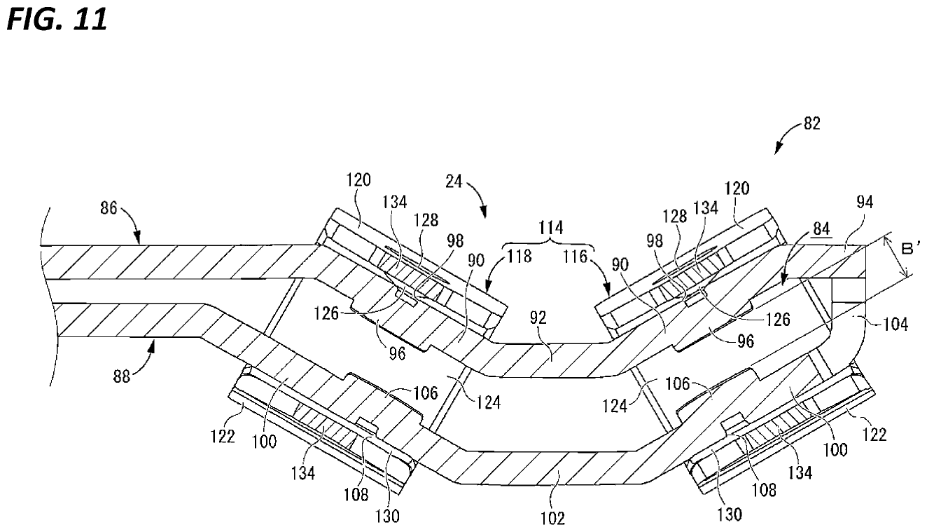

In the second embodiment, top parts of the first contact point portions 96 and those of the second contact point portions 106 linearly extend in an oblique direction inclined upward from an inner side toward an outer side in the front-rear direction, the top parts of the first contact point portions 96 and those of the second contact point portions 106 on the front side extend in parallel to each other, and the top parts of the first contact point portions 96 and those of the second contact point portions 106 on the rear side extend in parallel to each other. A separation distance between the top part of the first contact point portion 96 and that of the second contact point portion 106 is B′ in a state of FIG. 11 where the spring members 114 (first spring member 116 and second spring member 118) to be described later are assembled with the body portion 24 of the female terminal 82. This separation distance B′ between the top part of the first contact point portion 96 and that of the second contact point portion 106 is smaller than a plate thickness A′ (see FIG. 9) of the male terminal 12 (B′<A′), whereby the male terminal 12 can be press-fit into the male terminal press-fit gap 84.

Further, engaged portions 110, to which locking claws 136 of the spring members 114 (first spring member 116 and second spring member 118) to be described later are locked, are provided on one side surface (left end surface) in the plate width direction (lateral direction) of the second contact portion 88. In the second embodiment, a pair of stopper protrusions 112, 112 separated from each other in the front-rear direction (longitudinal direction of the first and second contact portions 86, 88) are provided to project laterally outward (leftward in the second embodiment) in the engaged portion 110 of the second contact portion 88. That is, a relatively recessed part is provided by providing the pair of stopper protrusions 112, 112 in the engaged portion 110 on the left end surface of the second contact portion 88, and the locking claws 136 of the first or second spring member 116, 118 are inserted into this recessed part and engaged with the left end surface, which is one side surface, of the second contact portion 88. Note that this engaged portion may be, for example, a recess directly formed in the left end surface of the second contact portion 88 without providing the aforementioned stopper protrusions 112 or may be provided in the lower surface of the second contact portion 88. Further, in the second embodiment, a pair of the engaged portions 110, 110 are provided apart from each other in the front-rear direction, specifically respectively provided on the pair of second inclined side edge parts 100, 100 separated from each other in the front-rear direction.

### (Spring Members 114)

The spring members 114 to be assembled with the body portion 24 of the female terminal 16 include the first spring member 116 to be arranged on one side (front side) in the front-rear direction and the second spring member 118 to be arranged on the other side (rear side) in the front-rear direction. Note that since the first and second spring members 116, 118 have the same shape, the first spring member 116 is described and the second spring member 118 is denoted using the same reference signs as the first spring member 116 in figures and not described in the following description.

### (First Spring Member 116 (Second Spring Member 118))

The first spring member 116 is constituted by a leaf spring clip including a first plate portion 120 to be overlapped on the outer surface (upper surface) of the first inclined side edge part 90, a second plate portion 122 to be overlapped on the outer surface (lower surface) of the second inclined side edge part 100 and a coupling plate portion 124 coupling these first and second plate portions 120, 122. The first and second plate portions 120, 122 respectively extend toward one side in a plate thickness direction of the coupling plate portion 124 from upper and lower ends of the coupling plate portion 124, and are facing each other in the vertical direction while being spaced apart by a predetermined distance. These first and second plate portions 120, 122 are resiliently deformable in directions away from or toward each other.

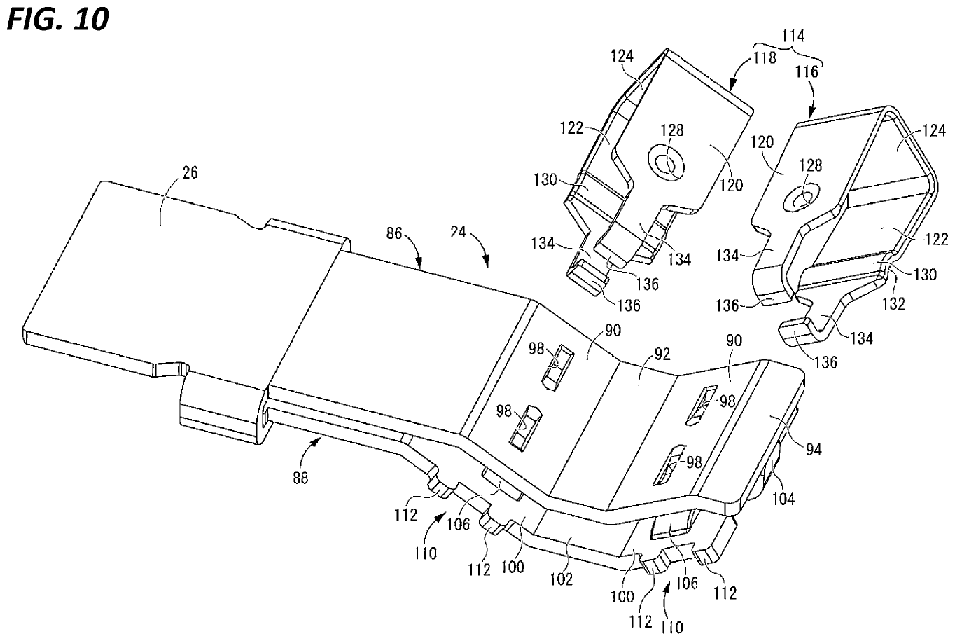

As also shown in FIGS. 9 and 10, the first plate portion 120 is in the form of a flat plate having a substantially rectangular or pentagonal shape, and a first protrusion 126 projecting downward is provided near an end part of the first plate portion 120 on a side opposite to a side connected to the coupling plate portion 124. This first protrusion 126 has a hemispherical shape, and a recess 128 open upward is formed at a position corresponding to the first protrusion 126 in the upper surface of the first plate portion 120.

Further, the second plate portion 122 is in the form of a flat plate having a substantially rectangular shape, and a second protrusion 130 continuously extending in a width direction (i.e. the front-rear direction) of the second plate portion 122 while having an arcuate cross-sectional convex toward the first plate portion 120 is provided near an end part of the second plate portion 122 on a side opposite to a side connected to the coupling plate portion 124. This second protrusion 130 is provided over an entire length in the width direction of the second plate portion 122, and a recess 132 open downward is formed at a position corresponding to the second protrusion 130 in the lower surface of the second plate portion 122.

In these first and second plate portions 120, 122, an extending portion 134 extending further in an extending direction from the coupling plate portion 124 is provided on the end part on the side opposite to the side connected to the coupling plate portion 124. In the first and second spring members 120, 122, the locking claw 136 projecting inward in a facing direction, i.e. toward the male terminal press-fit gap 84, is provided on an extending end part (tip part) of each of the extending portions 134 facing each other in the vertical direction.

Although not shown, a separation distance between a top part of the first protrusion 126 and that of the second protrusion 130 is smaller than a separation distance between the outer surface (upper surface) of the first inclined side edge part 90 and the outer surface (lower surface) of the second inclined side edge part 100 as in the first embodiment before the first and second spring members 116, 118 are assembled with the body portion 24 of the female terminal 82. In this way, when the first and second spring members 116, 118 are assembled with the body portion 24, biasing forces by the first and second spring members 116, 118 are applied to the respective first inclined side edge parts 90 and the respective second inclined side edge parts 100 and the first inclined side edge parts 90 and the second inclined side edge parts 100 are biased in the directions toward each other by the first and second spring members 116, 118.

The terminal unit 80 of the second embodiment can be assembled by an assembly process similar to that of the terminal unit 10 of the first embodiment. That is, the first and second spring members 116, 118 are assembled with the body portion 24 of the female terminal 82 formed by press-working or the like from right. In this way, the respective first plate portions 120 are overlapped on the outer surfaces of the respective first inclined side edge parts 90 and the respective second plate portions 122 are overlapped on the outer surfaces of the respective second inclined side edge parts 100. Further, each locking claw 136 provided on the first and second spring members 116, 118 is locked to the left end surface, which is one surface, of the first or second contact portion 86, 88. Particularly, each locking claw 136 provided on each of the second plate portions 122 of the first and second spring members 116, 118 is inserted between the both stopper protrusions 112, 112 at each engaged portion 110 of the second contact portion 88 and locked to the left end surface of the second contact portion 88. In this way, the first and second spring members 116, 118 are assembled with the body portion 24 of the female terminal 82, and the female terminal 82 is completed.

In a completed state of the female terminal 82, the respective first protrusions 126 of the respective first plate portions 120 of the first and second spring members 116, 118 are in point contact with parts of the outer surfaces of the first inclined side edge parts 90 between the recesses 98, 98 separated in the lateral direction. Further, the respective second protrusions 130 on the respective second plate portions 122 of the first and second spring members 116, 118 are in line contact with parts of the outer surfaces of the second inclined side edge parts 100 between the recesses 108 and 108 separated in the lateral direction. In this way, resilient restoring forces of the first and second plate portions 120, 122 are applied to the first and second inclined side edge parts 90, 100 as biasing forces in the directions toward each other. As a result, the abutting portion 94 of the first contact portion 86 and the abutted portion 104 of the second contact portion 88 come into contact with each other to limit any further displacement of the first and second inclined side edge parts 90, 100 in the approaching directions.

The male terminal 12 is inserted from left into the male terminal press-fit gap 84 of the female terminal 82 in the completed state. The male terminal 12 is press-fit and inserted into the male terminal press-fit gap 84. That is, the respective first contact point portions 96 and the respective second contact point portions 106 are pushed wider apart against the biasing forces of the first and second spring members 116, 118 by the male terminal 12, and the first and second contact portions 86, 88 are displaced in directions separating from each other. In this way, the male terminal 12 can be press-fit into the male terminal press-fit gap 84 and, as shown in FIG. 9, the male terminal 12 and the female terminal 82 are fit to complete the terminal unit 10.

Also in the terminal unit 80 of the second embodiment, the respective inclined portions 18 of the male terminal 12 are arranged between the respective first inclined side edge parts 90 and the respective second inclined side edge parts 100 biased by the first and second spring members 116, 118, and the respective first contact point portions 96 and the respective second contact point portions 106 are pressed against the respective inclined portions 18 of the male terminal 12. Thus, effects similar to those of the terminal unit 10 of the first embodiment are exhibited.

Particularly, in the second embodiment, the pair of first inclined side edge parts 90 are provided apart in the front-rear direction in the front end part of the first contact portion 86 and the pair of second inclined side edge parts 100 are provided apart in the front-rear direction in the front end part of the second contact portion 88, and a space between these first and second contact portions 86, 88 facing each other serves as the male terminal press-fit gap 84 open forward. In this way, the female terminal 82 and the terminal unit 80 can be configured to have a relatively simple shape.

Further, each of the first and second spring members 116, 118 is provided with the locking claws 136, and the respective locking claws 136 of the first and second spring members 116, 118 mounted on the body portion 24 of the female terminal 82 from right are locked to the side surfaces (left end surfaces) of the first and second contact portions 86, 88. In this way, the first and second spring members 116, 118 are prevented from being displaced rightward and detached from the body portion 24. Particularly, on the left end surface of the second contact portion 88, the pairs of stopper protrusions 112, 112 constituting the engaged portions 110 and separated in the front-rear direction are provided, and each locking claw 136 provided on each second plate portion 122 is inserted between these stopper protrusions 112, 112. Thus, the first and second spring members 116, 118 are also prevented from being displaced in the front-rear direction with respect to the body portion 24. As a result, accidental detachment of the first and second spring members 116, 118 from the female terminal 82 is prevented, and desired pressing forces by the first and second spring members 116, 118 can be stably obtained even if the male terminal 12 is repeatedly inserted into and withdrawn from the female terminal 82.

### Modifications

Although the first and second embodiments have been described in detail above as specific examples of the present disclosure, the present disclosure is not limited by this specific description. The present disclosure includes modifications, improvements and the like within a range in which the aim of the present disclosure can be achieved. For example, the following modifications of the embodiments are also included in the technical scope of the present disclosure.

(1) In the above embodiments, the angle of inclination θ1 of the inclined portion 18 with respect to the central flat portion 20 in the male terminal 12, the angle of inclination θ2 of the first inclined side edge part 32, 90 with respect to the first flat portion 34, 92 in the first contact portion 28, 86 and the angle of inclination θ3 of the second inclined side edge part 44, 100 with respect to the second flat portion 46, 102 in the second contact portion 30, 88 are substantially equal, and the inclined portion 18, the first inclined side edge part 32, 90 and the second inclined side edge part 44, 100 are substantially parallel. However, there is no limitation to this mode. For example, the angles of inclination θ2, θ3 may be different from the angle of inclination θ1. In that case, for example, the formation positions, the shapes and the like of the first and second contact point portions projecting from the first and second inclined side edge parts may be so adjusted that the projecting directions of the first and second contact point portions are parallel to the plate thickness direction of the inclined portion of the male terminal.

(2) In the above embodiments, the male terminal 12, the first contact portion 28, 86 and the second contact portion 30, 88 respectively include the central flat portion 20, the first flat portion 34, 92 and the second flat portion 46, 102. However, for example, at least one of the central flat portion, the first flat portion and the second flat portion may not be provided, and a pair of inclined portions, a pair of first inclined side edge parts or a pair of second inclined side edge parts may be directly connected to each other without via the central flat portion, the first flat portion or the second flat portion.

(3) Although the first spring member 58, 116 and the second spring member 60, 118 are both constituted by spring clips in the above embodiments, conventionally known spring members such as coil springs may be, for example, adopted.

(4) The numbers, the shapes and the like of the first and second contact point portions are not limited to those described in the above embodiments. For example, the first and second contact point portions may both have a hemispherical shape and one or three or more first or second contact point portions may be provided in the press-fitting direction of the male terminal. Further, the numbers, the shapes and the like of the first and second contact point portions may be different from each other.

(5) The numbers, the shapes and the like of the first and second protrusions provided on the first and second spring members are not limited. For example, the first and second protrusions may both have a hemispherical shape and one or more first or second protrusions may be provided. Alternatively, the first and second protrusions may be both shaped to have an arcuate cross-section and extend straight.

### LIST OF REFERENCE NUMERALS

10 terminal unit (first embodiment)
12 male terminal
14 spring member
16 female terminal
18 inclined portion
20 central flat portion
22 male terminal press-fit gap
24 body portion
26 wire connecting portion
28 first contact portion
30 second contact portion
32 first inclined side edge part
34 first flat portion
36 transition portion
38 first contact point portion
40 recess
42 abutting portion
44 second inclined side edge part
46 second flat portion
48 transition portion
50 second contact portion
52 recess
54 engaged portion
56 abutted portion
58 first spring member
60 second spring member
62 first plate portion
64 second plate portion
66 coupling plate portion
68 first protrusion
70 recess
72 second protrusion
74 recess
76 locking claw
78 through hole
79 guiding taper
80 terminal unit (second embodiment)
82 female terminal
84 male terminal press-fit gap
86 first contact portion
88 second contact portion
90 first inclined side edge part
92 first flat portion
94 abutting portion
96 first contact point portion
98 recess
100 second inclined side edge part
102 second flat portion
104 abutted portion
106 second contact portion
108 recess
110 engaged portion
112 stopper protrusion
114 spring member
116 first spring member
118 second spring member
120 first plate portion
122 second plate portion
124 coupling plate portion
126 first protrusion
128 recess
130 second protrusion
132 recess
134 extending portion
136 locking claw

1. A terminal unit, comprising:
a plate-like male terminal; and
a female terminal to be connected to the male terminal,
the female terminal including a first contact portion and a second contact portion arranged to face each other across a male terminal press-fit gap, the male terminal being press-fit into and arranged in the male terminal press-fit gap, and spring members for biasing the first and second contact portions in directions toward each other,
the male terminal including a pair of inclined portions inclined toward one side in a plate thickness direction of the male terminal on both sides in a plate width direction intersecting a press-fitting direction into the male terminal press-fit gap,
the first contact portion of the female terminal including a pair of first inclined side edge parts facing a surface on the one side in the plate thickness direction of the male terminal, the first inclined side edge parts being inclined along the pair of inclined portions of the male terminal, a first contact point portion projecting toward the male terminal press-fit gap being provided on each first inclined side edge part,
the second contact portion of the female terminal including a pair of second inclined side edge parts facing a surface on the other side in the plate thickness direction of the male terminal, the second inclined side edge parts being inclined along the pair of inclined portions of the male terminal, a second contact point portion projecting toward the male terminal press-fit gap being provided on each second inclined side edge part,
the spring members including a first spring member for biasing the first and second inclined side edge parts arranged and located on one side in the plate width direction in directions toward each other and a second spring member for biasing the first and second inclined side edge parts arranged and located on the other side in the plate width direction in directions toward each other,
the first spring member pressing the first contact point portion of the first inclined side edge part and the second contact point portion of the second inclined side edge part located on the one side in the plate width direction against the inclined portion of the male terminal press-fit between the first and second contact point portions, and
the second spring member pressing the first contact point portion of the first inclined side edge part and the second contact point portion of the second inclined side edge part located on the other side in the plate width direction against the inclined portion of the male terminal press-fit between the first and second contact point portions.

2. The terminal unit according to claim 1, wherein:
the male terminal includes a central flat portion arranged between the pair of inclined portions in the plate width direction,
the first contact portion of the female terminal includes a first flat portion arranged between the pair of first inclined side edge parts in the plate width direction and facing and extending along the central flat portion of the male terminal, and
the second contact portion of the female terminal includes a second flat portion arranged between the pair of second inclined side edge parts in the plate width direction and facing and extending along the central flat portion of the male terminal.

3. The terminal unit according to claim 1, wherein the first contact portion of the female terminal includes an abutting portion, the second contact portion of the female terminal includes an abutted portion for coming into contact with the abutting portion, and displacements of the first and second contact portions in the directions toward each other are prevented by the contact of the abutting portion and the abutted portion.

4. The terminal unit according to claim 3, wherein the first contact portion includes a pair of the abutting portions respectively provided on the pair of first inclined side edge parts, the second contact portion includes a pair of the abutted portions respectively provided on the pair of second inclined side edge parts, and displacements of the respective first inclined side edge parts and the respective second inclined side edge parts in the directions toward each other are prevented by the contact of the respective abutting portions and the respective abutted portions.

5. The terminal unit according to claim 1, wherein each of the first and second spring members is constituted by a leaf spring clip including a first plate portion to be overlapped on an outer surface of the first inclined side edge part, a second plate portion to be overlapped on an outer surface of the second inclined side edge part and a coupling plate portion coupling the first and second plate portions.

6. The terminal unit according to claim 1, wherein:
each of the first and second contact portions of the female terminal has a rectangular plate shape, has one end side in a longitudinal direction coupled to a base end part of the female terminal and is cantilevered from the base end part,
the first inclined side edge part and the second inclined side edge part located on the one side in the plate width direction of the male terminal are provided on one side in the plate width direction of each of the first and second contact portions,
the first inclined side edge part and the second inclined side edge part located on the other side in the plate width direction of the male terminal are provided on the other side in the plate width direction of each of the first and second contact portions, and
the male terminal press-fit gap provided between facing surfaces of the first and second contact portions is open toward projecting end sides of the first and second contact portions.

7. The terminal unit according to claim 6, wherein:
a locking claw projecting toward the male terminal press-fit gap is provided on a tip part of at least one of the first and second plate portions of each of the first and second spring members, and
engaged portions are respectively provided on the one side and the other side in the plate width direction of the first and second contact portions at least in one of the first and second contact portions, and the respective locking claws of the first and second spring members are engaged with the engaged portions.

8. The terminal unit according to claim 6, wherein:
a through hole penetrating in a plate thickness direction is provided in the coupling plate portion of each of the first and second spring members,
the abutting portion and the abutted portion are provided to project outward in the plate width direction of the first and second contact portions and arranged by being inserted into the through hole of the first spring member on the one side in the plate width direction of the first and second contact portions, and
the abutting portion and the abutted portion are provided to project outward in the plate width direction of the first and second contact portions and arranged by being inserted into the through hole of the second spring member on the other side in the plate width direction of the first and second contact portions.

9. The terminal unit according to claim 5, wherein:
each of the first and second contact portions of the female terminal has a rectangular plate shape, has one end side in a longitudinal direction coupled to a base end part of the female terminal and is cantilevered from the base end part,
the first inclined side edge part and the second inclined side edge part located on the one side in a longitudinal direction plate width direction are provided on projecting end parts of the first and second contact portions,
the first inclined side edge part and the second inclined side edge part located on the other side in a longitudinal direction are provided on sides of the first and second contact portions closer to the base end part than the projecting end parts, and
the male terminal press-fit gap provided between facing surfaces of the first and second contact portions is open at one side surface in the plate width direction of each of the first and second contact portions.

10. The terminal unit according to claim 9, wherein:
a locking claw projecting toward the male terminal press-fit gap is provided on a tip part of at least one of the first and second plate portions of each of the first and second spring members, and
the locking claws are engaged with the one side surface of the first or second contact portions.

11. The terminal unit according to claim 10, wherein stopper protrusions are provided to project outward on both sides of an engaged part to be engaged with the locking claw in the longitudinal direction on the one side surface in the plate width direction of at least one of the first and second contact portions.

12. The terminal unit according to claim 1, wherein:
the first contact point portions on the first inclined side edge part are provided at a plurality of positions separated from each other in an insertion direction of the male terminal, and
the second contact point portions on the second inclined side edge part are provided at a plurality of positions separated from each other in the insertion direction of the male terminal.

13. The terminal unit according to claim 1, wherein:
the first and second spring members include first protrusions for applying biasing forces to the first inclined side edge parts in a concentrated manner and second protrusions for applying biasing forces to the second inclined side edge parts in a concentrated manner, and
the second protrusion continuously extends in an insertion direction of the male terminal while having an arcuate cross-sectional shape and the first protrusion has a hemispherical shape projecting toward an intermediate part in an extending direction of the second protrusion.

14. A female terminal used in the terminal unit according to claim 1.

15. A male terminal used in the terminal unit according to claim 1.
